(19) United States
(12) Patent Application Publication
(10) Pub. No.: US 2024/0418860 A1
(43) Pub. Date: Dec. 19, 2024

(54) METHOD AND SYSTEM FOR VALIDATING END-TO-END LiDAR SENSING AND DIGITAL SIGNAL PROCESSOR OPTIMIZATION FOR 3D OBJECT DETECTION AND DEPTH ESTIMATION

(71) Applicant: Torc Robotics, Inc., Blacksburg, VA (US)

(72) Inventors: Felix Heide, New York City, NY (US); Mario Bijelic, Frankfurt (DE); Nicolas Robidoux, Montreal (CA)

(21) Appl. No.: 18/743,717

(22) Filed: Jun. 14, 2024

Related U.S. Application Data
(60) Provisional application No. 63/508,781, filed on Jun. 16, 2023.

(51) Int. Cl. G01S 17/894; G01S 7/481; G01S 7/4863; G01S 17/931; G06T 7/73

(52) U.S. Cl. CPC G01S 17/894; G01S 7/4817; G01S 7/4863; G01S 17/931; G06T 7/75; G06T 2207/10028; G06T 2207/20084

(57) ABSTRACT

A system including at least one memory and at least one processor configured to: (i) identify a set of hyperparameters affecting a wavefront and a pipeline processing a signal corresponding to a pulse received at a detector of a light detection and ranging (LiDAR) sensor; (ii) identify a set of 3-dimensional (3D) objects for detection using a neural network with the set of hyperparameters optimized based at least in part on a Covariance Matrix Adaptation-Evolution Strategy (CMA-ES) and a square root of covariance matrix scale factor; (iii) detect the set of 3D objects from a plurality of LiDAR point clouds using the neural network with the optimized set of hyperparameters and using a manually tuned set of hyperparameters; and (iv) validate the neural network optimized set of hyperparameters and the manually tuned set of hyperparameters using an average precision based upon the detected set of 3D objects, is disclosed.

### CROSS-REFERENCE TO RELATED APPLICATIONS

This application claims priority to U.S. Provisional Patent Application No. 63/508,781, filed Jun. 16, 2023, entitled “SIGNAL PROCESSING OPTIMIZATION FOR AUTONOMOUS VEHICLE PERCEPTION SYSTEMS,” the entire content of which is hereby incorporated by reference in its entirety.

### TECHNICAL FIELD

The field of the disclosure relates generally to autonomous vehicles and, more specifically, to systems and methods for signal processing optimizations in autonomous vehicle perception systems employing light detection and ranging (LiDAR) sensors.

### BACKGROUND

Autonomous vehicles employ fundamental technologies such as, perception, localization, behaviors and planning, and control. Perception technologies enable an autonomous vehicle to sense and process its environment. Perception technologies process a sensed environment to identify and classify objects, or groups of objects, in the environment, for example, pedestrians, vehicles, or debris. Localization technologies determine, based on the sensed environment, for example, where in the world, or on a map, the autonomous vehicle is. Localization technologies process features in the sensed environment to correlate, or register, those features to known features on a map. Localization technologies may rely on inertial navigation system (INS) data. Behaviors and planning technologies determine how to move through the sensed environment to reach a planned destination. Behaviors and planning technologies process data representing the sensed environment and localization or mapping data to plan maneuvers and routes to reach the planned destination for execution by a controller or a control module. Controller technologies use control theory to determine how to translate desired behaviors and trajectories into actions undertaken by the vehicle through its dynamic mechanical components. This includes steering, braking and acceleration.

LiDAR sensors are used for scanning the environment of the autonomous vehicle is a broadly adopted perception technology. LiDAR sensors emit pulses of light in all directions, and then examine the returned light. Since the emitted light may encounter unforeseen obstacles (e.g., reflection from multiple surfaces, or atmospheric conditions such as fog, rain, etc.) before it returns to a detector of the LiDAR sensor, extracting useful information from the signal received at the detector is a challenging and critical task performed by a digital signal processor (DSP). After the DSP decodes the signal, the decoded data is used to generate three-dimensional (3D) point clouds for downstream 3D vision modelling. Existing LiDAR DSPs are based upon cascades of parametrized operations requiring tuning of configuration parameters for improved 3D object detection, intersection of union (IoU) losses, or depth error metrics. However, known LiDAR sensor systems are generally available as fixed black boxes, and interfacing DSP hyperparameters for tuning configuration parameters is not straightforward.

This section is intended to introduce the reader to various aspects of art that may be related to various aspects of the present disclosure described or claimed below. This description is believed to be helpful in providing the reader with background information to facilitate a better understanding of the various aspects of the present disclosure. Accordingly, it should be understood that these statements are to be read in this light and not as admissions of prior art.

### SUMMARY

In one aspect, a system including at least one memory storing instructions and at least one processor in communication with the at least one memory is disclosed. The at least one processor is configured to execute the stored instructions to: (i) identify a set of hyperparameters affecting a wavefront and a pipeline processing a signal corresponding to a pulse received at a detector of a light detection and ranging (LiDAR) sensor, wherein the pulse is emitted using a channel of a plurality of channels of the LiDAR sensor; (ii) identify a set of 3-dimensional (3D) objects for detection using a neural network with the set of hyperparameters optimized based at least in part on a Covariance Matrix Adaptation-Evolution Strategy (CMA-ES) and a square root of covariance matrix scale factor; (iii) detect the set of 3D objects from a plurality of LiDAR point clouds using the neural network with the optimized set of hyperparameters; (iv) detect the set of 3D objects from the plurality of LiDAR point clouds using a manually tuned set of hyperparameters; and (v) validate the neural network optimized set of hyperparameters and the manually tuned set of hyperparameters using an average precision based upon the detected set of 3D objects corresponding to the optimized set of hyperparameters and the manually tuned set of hyperparameters.

In another aspect, a computer-implemented method is disclosed. The computer-implemented method includes (i) identifying a set of hyperparameters affecting a wavefront and a pipeline processing a signal corresponding to a pulse received at a detector of a light detection and ranging (LiDAR) sensor, wherein the pulse is emitted using a channel of a plurality of channels of the LiDAR sensor; (ii) identifying a set of 3-dimensional (3D) objects for detection using a neural network with the set of hyperparameters optimized based at least in part on a Covariance Matrix Adaptation-Evolution Strategy (CMA-ES) and a square root of covariance matrix scale factor; (iii) detecting the set of 3D objects from a plurality of LiDAR point clouds using the neural network with the optimized set of hyperparameters; (iv) detecting the set of 3D objects from the plurality of LiDAR point clouds using a manually tuned set of hyperparameters; and (v) validating the neural network optimized set of hyperparameters and the manually tuned set of hyperparameters using an average precision based upon the detected set of 3D objects corresponding to the optimized set of hyperparameters and the manually tuned set of hyperparameters.

In yet another aspect, a vehicle including a light detection and ranging (LiDAR) sensor, at least one memory storing instructions and at least one processor in communication with the at least one memory is disclosed. The at least one processor is configured to execute the stored instructions to: (i) identify a set of hyperparameters affecting a wavefront and a pipeline processing a signal corresponding to a pulse received at a detector of the LiDAR sensor, wherein the pulse is emitted using a channel of a plurality of channels of the LiDAR sensor; (ii) identify a set of 3-dimensional (3D) objects for detection using a neural network with the set of hyperparameters optimized based at least in part on a Covariance Matrix Adaptation-Evolution Strategy (CMA-ES) and a square root of covariance matrix scale factor; (iii) detect the set of 3D objects from a plurality of LiDAR point clouds using the neural network with the optimized set of hyperparameters; (iv) detect the set of 3D objects from the plurality of LiDAR point clouds using a manually tuned set of hyperparameters; and (v) validate the neural network optimized set of hyperparameters and the manually tuned set of hyperparameters using an average precision based upon the detected set of 3D objects corresponding to the optimized set of hyperparameters and the manually tuned set of hyperparameters.

Various refinements exist of the features noted in relation to the above-mentioned aspects. Further features may also be incorporated in the above-mentioned aspects as well. These refinements and additional features may exist individually or in any combination. For instance, various features discussed below in relation to any of the illustrated examples may be incorporated into any of the above-described aspects, alone or in any combination.

### BRIEF DESCRIPTION OF DRAWINGS

The patent or application file contains at least one drawing executed in color. Copies of this patent or patent application publication with color drawings will be provided by the Office upon request and payment of the necessary fee.

The following drawings form part of the present specification and are included to further demonstrate certain aspects of the present disclosure. The disclosure may be better understood by reference to one or more of these drawings in combination with the detailed description of specific embodiments presented herein.

FIG. 1 is a schematic view of an autonomous truck;

FIG. 2 is a block diagram of the autonomous truck shown in FIG. 1;

FIG. 3 is a block diagram of an example computing system;

FIG. 4 is an illustration of various conditions for LiDAR point cloud formation;

FIG. 5 is a functional block diagram of an example LiDAR simulation method;

FIG. 6 is an illustration of an example LiDAR sensing and DSP model;

FIG. 7 is a block of pseudo-code for an example LiDAR hyperparameter optimization algorithm;

FIG. 8 is a table showing an example comparison of the optimization algorithm shown in FIG. 7 with other state-of-the-art multi-objective optimization (MOO) optimizers;

FIG. 9 is a table showing an example comparison of hyperparameter optimization by an expert in comparison with the hyperparameter optimization algorithm shown in FIG. 7;

FIG. 10 is an illustration of an example comparison between ground-truth, expert-tuned and optimized point cloud for 3D object detection;

FIG. 11 is an illustration of an example comparison between expert-tuned and optimized point clouds in which colors encode the individual depth error of each point;

FIG. 12 is an illustration of an example test fixture with a photograph of an example scene over which optimization is performed;

FIG. 13 is a flow-chart of method operations for modeling realistic transient scene response using LiDAR wavefront simulation environment;

FIG. 14 is a flow-chart of method operations for optimization of LiDAR sensor hyperparameters; and

FIG. 15 is a flow-chart of method operations for validating end-to-end LiDAR sensing and DSP optimization for 3D object detection and depth estimation.

Corresponding reference characters indicate corresponding parts throughout the several views of the drawings. Although specific features of various examples may be shown in some drawings and not in others, this is for convenience only. Any feature of any drawing may be referenced or claimed in combination with any feature of any other drawing.

### DETAILED DESCRIPTION

The following detailed description and examples set forth preferred materials, components, and procedures used in accordance with the present disclosure. This description and these examples, however, are provided by way of illustration only, and nothing therein shall be deemed to be a limitation upon the overall scope of the present disclosure. The following terms are used in the present disclosure as defined below.

An autonomous vehicle: An autonomous vehicle is a vehicle that is able to operate itself to perform various operations such as controlling or regulating acceleration, braking, steering wheel positioning, and so on, without any human intervention. An autonomous vehicle has an autonomy level of level-4 or level-5 recognized by National Highway Traffic Safety Administration (NHTSA).

A semi-autonomous vehicle: A semi-autonomous vehicle is a vehicle that is able to perform some of the driving related operations such as keeping the vehicle in lane and/or parking the vehicle without human intervention. A semi-autonomous vehicle has an autonomy level of level-1, level-2, or level-3 recognized by NHTSA.

A non-autonomous vehicle: A non-autonomous vehicle is a vehicle that is neither an autonomous vehicle nor a semi-autonomous vehicle. A non-autonomous vehicle has an autonomy level of level-0 recognized by NHTSA.

Various embodiments described herein correspond with systems and methods for optimizing LiDAR sensing and DSP parameters (or hyperparameters) for a downstream task such as, a 3D object detection task, a vehicle localization task, a road surface detection task, or a lane geometry identification task, etc. As described herein, optimization of LiDAR system parameters is performed using a realistic LiDAR simulation method generating raw waveforms as input to a LiDAR DSP pipeline. Additionally, LiDAR parameters (or hyperparameters) are optimized for 3D object detection IoU losses or depth error metrics, or both, by solving a nonlinear multi-objective optimization (MOO) problem with a 0^{th}-order stochastic algorithm. In some embodiments, and by way of a non-limiting example, the methods described herein for 3D object detection tasks may outperform manual expert tuning by up to about 39.5% mean Average Precision (mAP), or more.

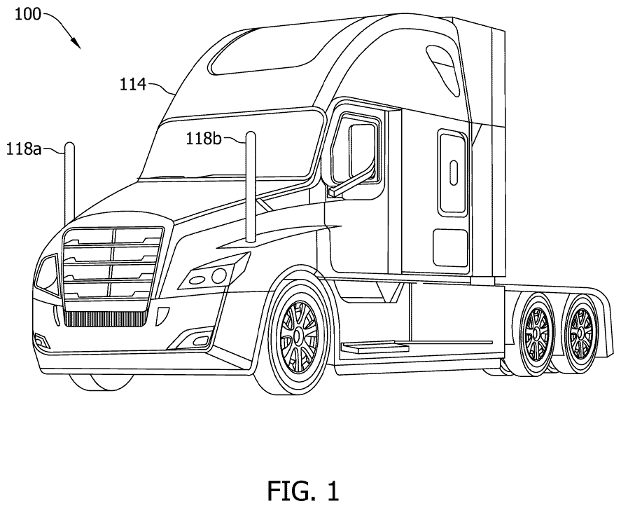

Various embodiments in the present disclosure are described with reference to FIGS. 1-15 below.

FIG. 1 illustrates a vehicle 100, such as a truck that may be conventionally connected to a single or tandem trailer to transport the trailer (not shown) to a desired location. The vehicle 100 includes a cabin 114 that can be supported by, and steered in the required direction, by front wheels and rear wheels that are partially shown in FIG. 1. Front wheels are positioned by a steering system that includes a steering wheel and a steering column (not shown in FIG. 1). The steering wheel and the steering column may be located in the interior of cabin 114.

The vehicle 100 may be an autonomous vehicle, in which case the vehicle 100 may omit the steering wheel and the steering column to steer the vehicle 100. Rather, the vehicle 100 may be operated by an autonomy computing system (not shown) of the vehicle 100 based on data collected by a sensor network (not shown in FIG. 1) including one or more sensors.

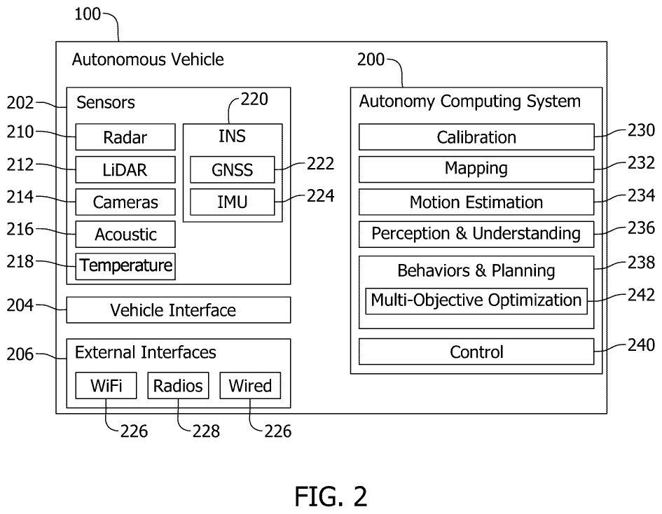

FIG. 2 is a block diagram of autonomous vehicle 100 shown in FIG. 1. In the example embodiment, autonomous vehicle 100 includes autonomy computing system 200, sensors 202, a vehicle interface 204, and external interfaces 206.

In the example embodiment, sensors 202 may include various sensors such as, for example, radio detection and ranging (RADAR) sensors 210, light detection and ranging (LiDAR) sensors 212, cameras 214, acoustic sensors 216, temperature sensors 218, or inertial navigation system (INS) 220, which may include one or more global navigation satellite system (GNSS) receivers 222 and one or more inertial measurement units (IMU) 224. Other sensors 202 not shown in FIG. 2 may include, for example, acoustic (e.g., ultrasound), internal vehicle sensors, meteorological sensors, or other types of sensors. Sensors 202 generate respective output signals based on detected physical conditions of autonomous vehicle 100 and its proximity. As described in further detail below, these signals may be used by autonomy computing system 200 to determine how to control operations of autonomous vehicle 100.

Cameras 214 are configured to capture images of the environment surrounding autonomous vehicle 100 in any aspect or field of view (FOV). The FOV can have any angle or aspect such that images of the areas ahead of, to the side, behind, above, or below autonomous vehicle 100 may be captured. In some embodiments, the FOV may be limited to particular areas around autonomous vehicle 100 (e.g., forward of autonomous vehicle 100, to the sides of autonomous vehicle 100, etc.) or may surround 360 degrees of autonomous vehicle 100. In some embodiments, autonomous vehicle 100 includes multiple cameras 214, and the images from each of the multiple cameras 214 may be processed for 3D objects detection in the environment surrounding autonomous vehicle 100. In some embodiments, the image data generated by cameras 214 may be sent to autonomy computing system 200 or other aspects of autonomous vehicle 100 or a hub or both.

LiDAR sensors 212 generally include a laser generator and a detector that send and receive a LiDAR signal such that LiDAR point clouds (or “LiDAR images”) of the areas ahead of, to the side, behind, above, or below autonomous vehicle 100 can be captured and represented in the LiDAR point clouds. RADAR sensors 210 may include short-range RADAR (SRR), mid-range RADAR (MRR), long-range RADAR (LRR), or ground-penetrating RADAR (GPR). One or more sensors may emit radio waves, and a processor may process received reflected data (e.g., raw RADAR sensor data) from the emitted radio waves. In some embodiments, the system inputs from cameras 214, RADAR sensors 210, or LiDAR sensors 212 may be used in combination in perception technologies of autonomous vehicle 100.

GNSS receiver 222 is positioned on autonomous vehicle 100 and may be configured to determine a location of autonomous vehicle 100, which it may embody as GNSS data. GNSS receiver 222 may be configured to receive one or more signals from a global navigation satellite system (e.g., Global Positioning System (GPS) constellation) to localize autonomous vehicle 100 via geolocation. In some embodiments, GNSS receiver 222 may provide an input to or be configured to interact with, update, or otherwise utilize one or more digital maps, such as an HD map (e.g., in a raster layer or other semantic map). In some embodiments, GNSS receiver 222 may provide direct velocity measurement via inspection of the Doppler effect on the signal carrier wave. Multiple GNSS receivers 222 may also provide direct measurements of the orientation of autonomous vehicle 100. For example, with two GNSS receivers 222, two attitude angles (e.g., roll and yaw) may be measured or determined. In some embodiments, autonomous vehicle 100 is configured to receive updates from an external network (e.g., a cellular network). The updates may include one or more of position data (e.g., serving as an alternative or supplement to GNSS data), speed/direction data, orientation or attitude data, traffic data, weather data, or other types of data about autonomous vehicle 100 and its environment.

IMU 224 is a micro-electrical-mechanical (MEMS) device that measures and reports one or more features regarding the motion of autonomous vehicle 100, although other implementations are contemplated, such as mechanical, fiber-optic gyro (FOG), or FOG-on-chip (SiFOG) devices. IMU 224 may measure an acceleration, angular rate, or an orientation of autonomous vehicle 100 or one or more of its individual components using a combination of accelerometers, gyroscopes, or magnetometers. IMU 224 may detect linear acceleration using one or more accelerometers and rotational rate using one or more gyroscopes and attitude information from one or more magnetometers. In some embodiments, IMU 224 may be communicatively coupled to one or more other systems, for example, GNSS receiver 222 and may provide input to and receive output from GNSS receiver 222 such that autonomy computing system 200 is able to determine the motive characteristics (acceleration, speed/direction, orientation/attitude, etc.) of autonomous vehicle 100.

In the example embodiment, autonomy computing system 200 employs vehicle interface 204 to send commands to the various aspects of autonomous vehicle 100 that actually control the motion of autonomous vehicle 100 (e.g., engine, throttle, steering wheel, brakes, etc.) and to receive input data from one or more sensors 202 (e.g., internal sensors). External interfaces 206 are configured to enable autonomous vehicle 100 to communicate with an external network via, for example, a wired or wireless connection, such as Wi-Fi 226 or other radios 228. In embodiments including a wireless connection, the connection may be a wireless communication signal (e.g., Wi-Fi, cellular, LTE, 5G, 6G, Bluetooth, etc.).

In some embodiments, external interfaces 206 may be configured to communicate with an external network via a wired connection 244, such as, for example, during testing of autonomous vehicle 100 or when downloading mission data after completion of a trip. The connection(s) may be used to download and install various lines of code in the form of digital files (e.g., HD maps), executable programs (e.g., navigation programs), and other computer-readable code that may be used by autonomous vehicle 100 to navigate or otherwise operate, either autonomously or semi-autonomously. The digital files, executable programs, and other computer readable code may be stored locally or remotely and may be routinely updated (e.g., automatically, or manually) via external interfaces 206 or updated on demand. In some embodiments, autonomous vehicle 100 may deploy with all of the data it needs to complete a mission (e.g., perception, localization, and mission planning) and may not utilize a wireless connection or other connections while underway.

In the example embodiment, autonomy computing system 200 is implemented by one or more processors and memory devices of autonomous vehicle 100. Autonomy computing system 200 includes modules, which may be hardware components (e.g., processors or other circuits) or software components (e.g., computer applications or processes executable by autonomy computing system 200), configured to generate outputs, such as control signals, based on inputs received from, for example, sensors 202. These modules may include, for example, a calibration module 230, a mapping module 232, a motion estimation module 234, a perception and understanding module 236, a behaviors and planning module 238, a control module or controller 240, and a multi-objective optimization (MOO) module 242. The MOO module 242, for example, may be embodied within another module, such as behaviors and planning module 238, or perception and understanding module 236, or separately. These modules may be implemented in dedicated hardware such as, for example, an application specific integrated circuit (ASIC), field programmable gate array (FPGA), a digital signal processor (DSP), or microprocessor, or implemented as executable software modules, or firmware, written to memory and executed on one or more processors onboard autonomous vehicle 100.

The MOO module 242 may perform one or more tasks including, but not limited to, setting or generating a LiDAR wavefront simulation environment that models realistic transient scene responses, implementing an optimization method for balance multi-objective black-box optimization of LiDAR sensor hyperparameters, or validating end-to-end LiDAR sensing and DSP optimization for 3D object detection and error depth estimation.

Autonomy computing system 200 of autonomous vehicle 100 may be completely autonomous (fully autonomous) or semi-autonomous. In one example, autonomy computing system 200 can operate under Level 5 autonomy (e.g., full driving automation), Level 4 autonomy (e.g., high driving automation), or Level 3 autonomy (e.g., conditional driving automation). As used herein the term “autonomous” includes both fully autonomous and semi-autonomous.

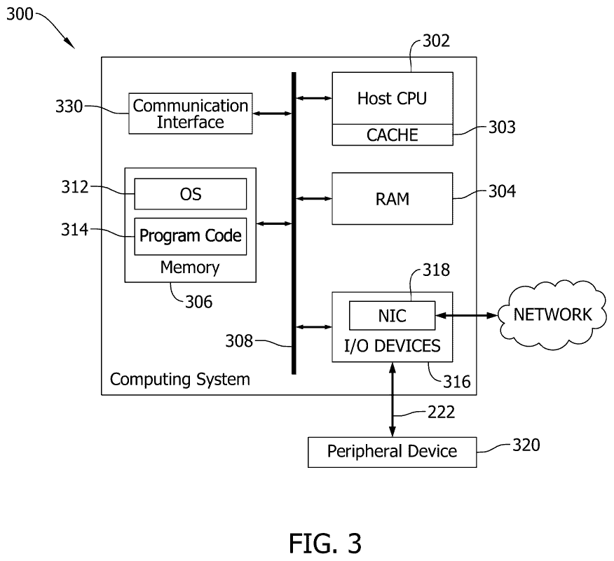

FIG. 3 is a block diagram of an example computing system 300, such as an application server at a hub. Computing system 300 includes a CPU 302 coupled to a cache memory 303, and further coupled to RAM 304 and memory 306 via a memory bus 308. Cache memory 303 and RAM 304 are configured to operate in combination with CPU 302. Memory 306 is a computer-readable memory (e.g., volatile, or non-volatile) that includes at least a memory section storing an OS 312 and a section storing program code 314. Program code 314 may be one of the modules in the autonomy computing system 200 shown in FIG. 2. In alternative embodiments, one or more section of memory 306 may be omitted and the data stored remotely. For example, in certain embodiments, program code 314 may be stored remotely on a server or mass-storage device and made available over a network 332 to CPU 302.

Computing system 300 also includes I/O devices 316, which may include, for example, a communication interface such as a network interface controller (NIC) 318, or a peripheral interface for communicating with a peripheral device 320 over a peripheral link 322. I/O devices 316 may include, for example, a GPU for image signal processing, a serial channel controller or other suitable interface for controlling a sensor peripheral such as one or more acoustic sensors, one or more LiDAR sensors, one or more cameras, one or more weight sensors, a keyboard, or a display device, etc.

As described herein, environment perception for autonomous drones and vehicles requires precise depth sensing for safety-critical control decisions. Scanning LiDAR sensors have been broadly adopted in autonomous driving as they provide high temporal and spatial resolution, and recent advances in MEMS scanning and photodiode technology have reduced their cost and form factor.

In the 3D detection methods described herein, 3D point cloud (PC) data is taken as input. The 3D PC data is produced by a LiDAR and digital signal processor (DSP) pipeline with many measurements and processing steps. As described herein, typical LiDAR sensors operate by emitting a laser pulse and measuring the temporal response through a detector, e.g., an Avalanche Photo Diode (APD) detector. This temporal wavefront signal is fed to a DSP that extracts peaks corresponding to echoes from candidate targets within the environment. As such, DSP processing may result in a 1000-fold data reduction for a single emitted beam, producing single or multiple 3D points per beam. Compressing the waveform into points in 3D space with minimal information loss is challenging because of object discontinuities, sub-surface scattering, multipath reflections, and scattering media, etc.

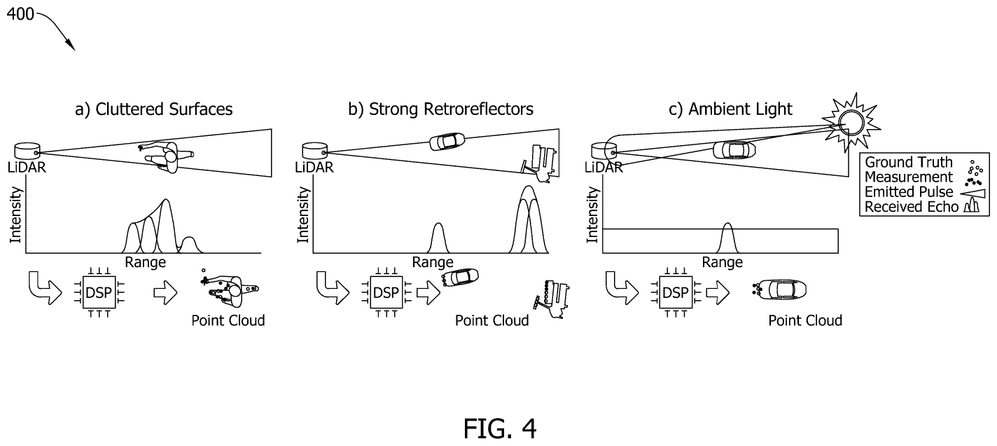

FIG. 4 is an illustration 400 of various example conditions for LiDAR point cloud formation. During the LiDAR point cloud formation, significant scattering generally occurs in adverse weather conditions like fog, rain, and snow. Generally, LiDAR sensor point cloud measurements are produced by a multi-state measurement and signal processing chain. The LiDAR sensor emits a laser pulse, which travels through an environment and returns to a detector of the LiDAR sensor after single or multiple reflections. Cluttered surfaces (a), strong retroreflectors (b), and ambient light (c) are example conditions that may be introduced in the signal returned to the detector. Accordingly, a full transient waveform read by the LiDAR sensor is a superposition of multiple return paths. The DSP, which is a chain of hardware- or software-defined processing blocks, processes all temporal waveforms and extracts a continuous stream of 3D points that forms the final point cloud. Such conditions can degrade the LiDAR point cloud product and are conventionally addressed by manually adjusting internal sensing and DSP parameters in controlled environments and restricted real-world scenarios using a combination of visual inspection and depth quality metrics.

Generally, LiDAR sensor systems are black boxes with configuration parameters hidden from the user. In some embodiments, to account for noisy point cloud measurements with spurious artifacts, simulated adverse effects and point cloud degradations that model rain, fog and snow may be added to LiDAR datasets of LiDAR systems that are referenced in the present disclosure as black-box LiDAR systems. Additionally, downstream vision models are retrained for predictions using augmented point clouds that are more robust to point cloud data corruption. Additionally, or alternatively, synthetic measurements from 3D scenes may be generated using rendering engines. However, currently known methods avoid simulating transient light propagation and signal processing by converting 3D scene depth directly into a point cloud. As a result, known methods lack physically realistic modeling of fluctuations arising from multipath effects or measurement noise. Further, known simulation methods that alter measurements or generate synthetic point clouds generally do not optimize sensing or DSP parameters for downstream vision performance. Embodiments described herein addresses these shortcomings of known LiDAR systems and DSP methods of optimizations.

In some embodiments, LiDAR pulse configuration and DSP hyperparameters for end-to-end downstream 3D object detector losses and PC depth quality metrics may be optimized as described herein. Optimization of LiDAR pulse configuration and DSP hyperparameters is a challenging task because hyperparameter space generally involves tens to hundreds of categorical, discrete, and effectively continuous parameters affecting downstream tasks in complex nonlinear ways via an intermediate point cloud. Examples of categorical hyperparameters include Velodyne LiDAR sensor return modes, which is an example of a continuous hyperparameter, and configured internal wave-front peak selection algorithms for point cloud formation rotation velocity, which impacts angular resolution.

As described herein, grid search optimization is impractical because of combinatorial explosion. 0^{th}-order stochastic algorithm can find camera DSP hyperparameters that improve downstream 2D object detectors. An optimization method for LiDAR sensing and DSP hyperparameters, as described herein, may minimize end-to-end domain-specific losses such as root mean squared error (RMSE) of the measured depth against ground truth and IoU measured on downstream 3D object detection. In some embodiments, and by way of a non-limiting example, a LiDAR simulation method based on the Car Learning to Act (CARLA) engine that models a LiDAR DSP as well as the full transient noisy waveform formed by multiple laser echoes may be used in which sensing and DSP hyperparameters are optimized by solving a Multi-Objective black-box Optimization (MOO) problem with a novel Covariance Matrix Adaptation-Evolution Strategy (CMA-ES) that relies on a max-rank multi-objective scalarization loss to dynamically improve scale matching between different loss components. Additionally, a balanced Pareto-optimal solution for which no loss component has a comparatively poor value for LiDAR optimization with multiple objectives may also be used with the proposed LiDAR simulation method. In some embodiments, validation method of the proposed optimization method for 3D object detection and point cloud depth estimation, as described herein, may be used for validating the proposed optimization method in simulation and using an off-the-shelf experimental LiDAR sensor.

In other words, embodiments in the present disclosure describe (i) a LiDAR wavefront simulation for the CARLA simulation environment that models realistic transient scene responses; (ii) a multi-objective optimization method for balanced MOO of LiDAR parameters; and (iii) a method for validating end-to-end LiDAR sensing and DSP optimization for 3D object detection and depth estimation through simulation and with a real system.

### DSP and Sensor Hyperparameter Optimization

Optimization of sensors and DSPs for downstream vision tasks is disclosed. Conversely, known methods target camera image signal processors (ISPs) and optics. Instead of tuning hyperparameter manually by experts, optimization methods described herein may optimize the hyperparameters automatically, based upon one or more downstream performance metrics. As digital signal processor (DSP) and sensor hyperparameters can be categorical and losses are often non-convex and noisy, diverse optimization methods are described in the present disclosure.

Some optimization methods target specific processing blocks as differentiable programs or in a reduced parameter space or rely on differentiable pipeline proxies or 0th-order optimization, alone or in combination with block coordinate descent. One advantage of 0th-order optimizers is that they handle black box hardware and DSPs. 0th-order solvers used to optimize camera systems include MOEA/D and CMA-ES. These approaches successfully tackle camera pipeline optimization from the optics to downstream detectors. However, in the present disclosure, for an end-to-end LiDAR system optimization, a loss-driven method in which LiDAR hyperparameter optimization is performed automatically for improving performance of downstream depth and detection tasks.

### LiDAR Sensing and Point Cloud Generation

LiDAR sensors produce point clouds by emitting pulses of light into a scene and measuring the round trip time of sensor returns. Extracting a point cloud from time-of-flight measurements is a complex process that depends on measurement procedure specifics like beam formation, scanning, pulse/continuous wave generation, and peak finding within the acquired temporal laser response. LiDAR sensors differ in their scanning pattern, beam steering technology, wavelength, pulse profile, coherence of the measurement step, detector technology and DSP capabilities to process the measurement echoes.

As described herein, LiDAR sensors can extract single or multiple peaks resulting from multi-path interreflections in the scene. By way of a non-limiting example, for a single Lambertian reflector in the scene, the temporal resolution and signal-to-noise ratio (SNR) of the measurement are tied to laser power. Accordingly, in some optimization methods, automated runtime laser power adjustment may be used to maximize SNR while preventing oversaturation. Additionally, or alternatively, other approaches for adaptive beam steering may also be used. In some embodiments, beam configuration optimization may be performed via reinforcement learning methods driven by a downstream 3D detection loss, which predicts beam patterns, e.g., where to place sparse samples. Additionally, or alternatively, DSP hyperparameters corresponding to, but not limited to only, sensing, pulse power and scanning parameters may be optimized.

### LiDAR Simulation

To assess and validate the optimization method, a LiDAR simulation method that plugs directly into, for example, an open-source CARLA simulator is generally used in several simulation environments using simulation frameworks. Simulation frameworks enable creation of multimodal synthetic datasets, e.g., PreSIL, SHIFT, AIODrive and SYNTHIA. However, underlying simulation methods employ heuristic forward models, and none of the datasets include full waveform returns that allows simulating LiDAR point cloud generation. For example, the AIODrive dataset, in which multiple peaks are returned via depth image convolution and Single Photon Avalanche Diode (SPAD) quantization, bakes transients into SPAD image formation, which falls short of enabling realistic transient simulation. Similarly, real PC dataset augmentation methods that are employed to tackle rare occurring events like obstacles, traffic, rain, fog or snow. However, such augmentation methods fail to facilitate modeling of the DSP pipeline because the underlying datasets do not include the raw wavefronts. The disclosed simulation method simulates full wavefront signals that, when combined with a realistic DSP model, produces PC data representative of real systems.

### Transient LiDAR Forward Model

In some embodiments, for a single laser pulse emitted by a LiDAR unit or a LiDAR sensor into a 3D scene, from which a returned signal is detected by a SPAD detector. The SPAD detector then sends temporal histograms to the sensor DSP. For channel n at time t, the sensor-incident temporal photon flux may be defined as:

$${ψ}^{( n )} ( t ) = ( H * {g}^{( n )} ) ( t ) + a ( t ) , \qquad Eq . 1$$

In Eq. 1 above, g⁽ⁿ⁾ is the temporally varying photon flus emitted by the laser channel n, H is the transient response from the scene, α(t) is the ambient photon flux, and * is the temporal convolution operator.

The transient scene response H includes multipath returns from scene interreflections and scattering. The detector measures the returned signal and digitizes the temporal measurement into temporal wavefronts processed by the DSP. For low photon counts or path lengths above a few meters in automotive scenes, the binning process may be modeled as a Poisson random process. Consequently, the wavefront's number of photons r⁽ⁿ⁾ detected within the integration time Δ in channel n's time bin k may be modelled using Eq. 2 below.

$${r}^{( n )} [ k ] \sim Poisson {\int }_{k Δ}^{( k + 1 ) Δ} {Ψ}^{( n )} ( r ) dt , \qquad Eq . 2$$

### Transient Scene and Pulse Model

Based upon a linear model for direct laser reflections in the LiDAR context for the incident transient response H*g⁽ⁿ⁾ of Eq. 1, the transient response may be modeled as Eq. 3 below.

$$H * {g}^{( n )} ( R ) = C {\int }_{0}^{2 {T}^{( n )}} {g}^{( n )} ( t ) H R - \frac{ct}{2} dt , \qquad Eq , 3$$

In Eq. 3, R is the distance between the sensor and the observed point, c is the speed of light, C is proportionality constant independent of t and R describing the system, and 2T⁽ⁿ⁾ is the total pulse duration for channel n. Path length may be converted to time with t=R/c, and the pulse shape may be defined as Eq. 4 below.

$${g}^{( n )} ( r ) = {P}_{0}^{( n )} {sin}^{2} ( \frac{\prod T}{2 {T}^{( n )}} ) , if 0 \leq 0 \leq 2 {T}^{( n )} , otherwise 0 , \qquad Eq . 4$$

In Eq. 4, P₀⁽ⁿ⁾ is channel n's pulse power magnitude. The transient scene response H embedded in Eq. 3 includes geometric attenuation of the light, proportional to 1/(2R)², and the scene response. For a single opaque point object i, the latter is proportional to its reflectance ρᵢ and Dirac function δ(R−Rᵢ), where Rᵢ being the object distance to the sensor. Reformulating Eq. 3 for a single echo from the single opaque point object i may yield as:

$${( H * {g}^{( n )} )}_{i} ( R ) = {f}_{i}^{( n )} ( R ) , if {R}_{i} \leq R \leq Ri + {cT}^{( n )} , otherwise 0 , \qquad Eq . 5$$

$$With {f}_{i}^{( n )} ( R ) = \frac{C {ρ}_{0}^{( n )} {ρ}_{i}}{4 {R}_{i}^{2}} {( sin )}^{2} \frac{π}{{CT}^{( n )}} ( R - {R}_{i} ) , \qquad Eq . 6$$

### Object Reference Model

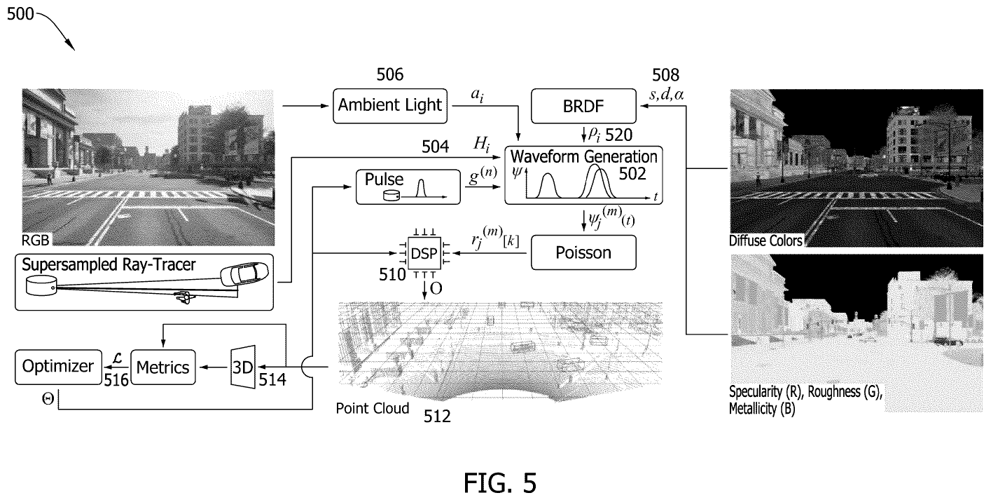

FIG. 5 is a functional block diagram of an example LiDAR simulation method 500. The LiDAR simulation method 500 may be a parameterizable LiDAR simulation model that generates full transient waveforms 502 by extracting scene response H 504, ambient light α 506, and object reflectances s, d, and a 508 from CARLA. End-to-end loss functions drive an MOO solver toward an optimal vector that includes both pulse and DSP hyperparameters. Wavefronts 502 are processed by the DSP 510 resulting in a point cloud 512. As shown in FIG. 5, the loop is closed by feeding or inputting the point cloud 512 to 3D object detection and depth estimation methods 514, and the output may be rated by loss functions 516. Validation datasets may cycle through the until the optimal vector converges. The object reflectance ρᵢ 520 depends on the material bidirectional reflectance distribution function (BRDF) 518 and the angle of incidence θ. The reflectance may be modeled using specular and diffuse components of the retroreflected portion of the Cook-Terrance model represented as Eq. 7 below:

$${ρ}_{i} = \frac{{α}^{4} s cos θ}{\begin{matrix}4 [ {cos}^{2} θ ( {a}^{4} - 1 ) + 1 ] [ {cos}^{2} θ ( {a}^{4} - 1 ) + 1 ] \\ [ cos θ ( 1 - k ) + k ] [ cos θ ( 1 - k ) + k ]\end{matrix}} + d cos θ , \qquad Eq . 7$$

In Eq. 7 above, s, d, and α∈[0,1] refer to the specular, diffuse and roughness properties of a surface material and k=(α+1)²/8. To render realistic textures without a large texture database, s, d, and α may be approximated through CARLA's Phong-like parameters s, d, and s, d, and α. Because these parameters are not directly accessible, these parameters are extracted by projecting targeted hit points onto custom camera images encoding their values, as illustrated in FIG. 5, and described below. By way of a non-limiting example, a function ρᵢ for a rendered image I_{sdα} returns pixel information at the location of projected point i that is |s, d, α|=ρᵢ (I_{sdα}).

### Ambient Illumination

The ambient light α(t) in Eq. (1) is modeled at a location i as projected on the red channel of a rendered RGB camera image in which shadows and reflections are properly accounted for; denote this image by I_{red}. Further, α(t) may be approximated as a constant over waveform time bins, that is, α(t)≡αᵢ=ρᵢ(Ired), where αᵢ is independent of t.

### Multiple Transients

Multipath transients for laser beams hitting object discontinuities may be taken as primary artifact sources in automotive scenarios. Multipath transients may be modeled as linear combinations of neighboring waveforms. Specifically, a supersampled collection of {Ri} and channels may be computed using direct illumination only; then, for each LiDAR channel and each horizontal angle, a downsampled waveform ψ_{J}^{(m)} may be obtained as:

$${ψ}_{J}^{( m )} ( R ) = {\sum }_{i ∈ N ( j ) , n ∈ N ( m )} ( {k}_{i}^{( n )} ( H * {g}^{( n )} ) i ( R ) + a ( i ) ) , \qquad Eq . 8$$

In Eq. 8, N(j) and N(m) define the spatial neighborhood of the target point j and the channel m, and the kᵢ⁽ⁿ⁾ are normalized weights that may be interpreted as a beam spatial intensity profile.

### LiDAR Sensing and DSP Model

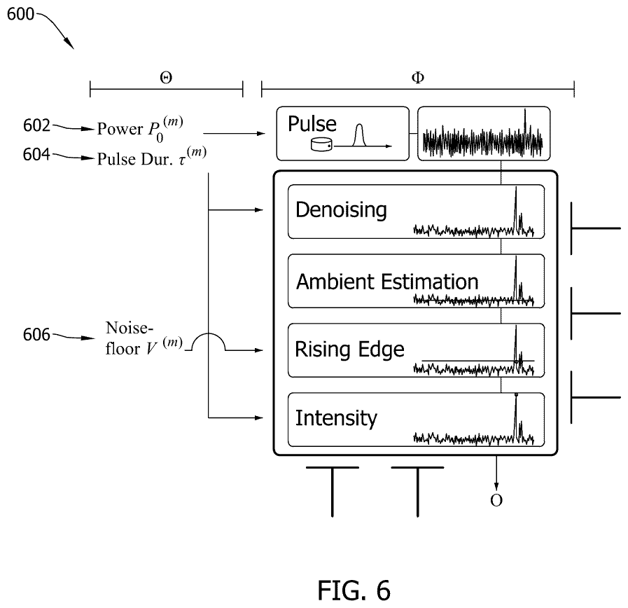

FIG. 6 is an illustration of an example LiDAR sensing and DSP model 600. The LiDAR sensor hyperparameters may include pulse power 602, duration 604, and parameters for rising edge detection 606 in a transient wavefront, which affects the quality of the generated point cloud. A sensor-incident waveform ψ_{J}^{(m)} is measured according to Eq. 2 and, along with sensor noise. The sensor-incident waveform may be subjected to clipping at a saturation level that depends on detector type. The DSP may convert noisy and saturated waveforms rⱼ^{(m)} into a point cloud O that includes range and intensity information. The entire process, from the emission of a laser pulse g^{(m)} to the output of a processed point cloud O may be as shown in FIG. 6, which is described in detail below.

In some embodiments, with compressed notation, LiDAR sensing may be modelled as a function Φ(θ) with hyperparameters θ=(P₀^{(m)}, T^{(m)}, V^{(m)}). Laser power P₀^{(m)} and pulse duration T^{(m)} are functions of the channel m, and determine the emitted pulse g^{(m)}. DSP noises by convolving the measured waveform rⱼ^{(m)} with the emitted pulse g^{(m)}, and ambient light may be estimated by removing the waveform's median form rⱼ^{(m)}, which allows the DSP to find adequate noise thresholds V^{(m)} since ambient light varies strongly throughout the scene. DSPs use a rising edge detector that finds peaks along the denoised waveform by identifying intersections with V^{(m)}. However, in some examples, multiple peaks may arise; the peak with the highest sensitivity may be added to the point cloud O. Additionally, by way of a non-limiting example, the maximum intensity may be compensated for the emitted laser pulse with the pulse half width T^{(m)}/2 and power level P₀^{(m)} may be used as scaling factors to recover the true intensities as shown in Eq. 3.

By way of an example, LiDAR sensors may have upward of 128 channels. Accordingly, optimizing every channel hyperparameter individually may be prohibitive. The Velodyne HDL-64 bundles lasers in two groups, and similarly LiDAR models may group lower and upper lasers. Within each group, hyperparameters modulation may be an affine function of the channel number with tunable slope and bias. The edge threshold may be modelled as a continuous parameter V^{(m)}∈[0,2]. In contrast, power levels P₀^{(m)} may take one of a predesignated number of values (e.g., 11 values), such that the lowest power level may make the peak almost indistinguishable from ambient noise and the highest power level may likely saturate at close range. Pulse duration T^{(m)} may take discrete values ranging from 3 to 15 ns in 1 ns increment.

### Optimization

A multi-objective optimization (MOO) method described herein finds Pareto-Optimal LiDAR hyperparameters. Using the MOO method, as described herein, high-quality point clouds for depth precision and optimal mAP may be generated and inputted to a downstream object detection module.

### LiDAR Hyperparameter Optimization

In some embodiments, hyperparameters may be optimized with loss-driven end-to-end optimization such that the system as a whole, including hardware functionality, for example, the laser beam power of each channel, with DSP functionality may be optimized. The operation of the LiDAR imaging pipeline Φ that is modulated by P hyperparameters θ=(θ₁, . . . , θₚ) with ranges of values normalized to the unit interval [0, 1]. With T>>2T, each of the J channels Φⱼ of Φ=(Φ₁, . . . Φ_{J}) may be modeled as:

$${Φ}_{j} {: [ - T , 0 ]}^{[ 0 , ∞ ]} {x [ 0 , 1 ]}^{P} \to {S}^{[ 0 , ∞ ]} , ( {r}_{j} , θ ) \to {O}_{j} , \qquad Eq . 9$$

In Eq. 9, Oⱼ may be a mapping from the unit sphere S (proxy for projective geometry) to nonnegative distance where 0 may be interpreted as “undefined” so that each Φⱼ may reconstruct a portion Oⱼ of the overall point cloud O from a waveform rⱼ truncated to the time interval [−T, 0]. The overall θ-modulated LiDAR pipeline may be defined as Eq. 10 below:

$$Φ : ( r ( H , θ ) , θ ) \to O , \qquad Eq . 10$$

The LiDAR pipeline as defined in Eq. 10 maps the set of truncated waveforms r=(r₁, . . . r_{J}) to the point cloud O including the compressed information available to downstream detectors about the changing scene H. Pareto-optimal with respect to the MOO loss vector [symbol] =( [symbol] ₁, . . . , [symbol] _{L}) may be defined as:

$$θ *= arg min ℒ ( θ ) , where θ ∈ {[ θ , 1 ]}^{P} , \qquad Eq . 11$$

In Eq. 11 above, loss components may not directly use the point cloud O; for example, [symbol] ₁ may use data tapped out of the pipeline (e.g., a channel's waveform rⱼ) or the output of a downstream detector (e.g., a deep convolutional neural network (CNN)), which ingests the point cloud O (e.g., mAP). The pareto front including Pareto-optimal compromises between losses may be the solution set of Eq. 11, and from which a single “champion” may be selected using additional criteria. In the present disclosure, the term “champion” refers to the best possible state returned by the optimization performing equally good on all metrices under investigation.

### Optimization Algorithm

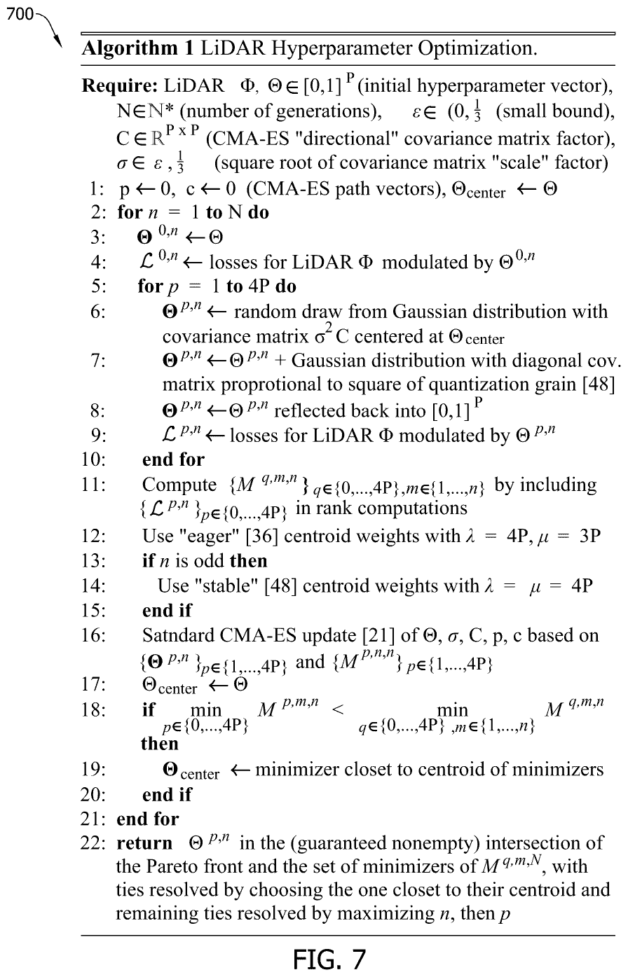

FIG. 7 is a block 700 of an example pseudo code for an example LiDAR hyperparameter optimization algorithm. The MOO problem may be solved using a variant of Covariance Matrix Adaptation-Evolution Strategy (CMA-ES) methods that differs from the state of the art in a number of ways. In an algorithm illustrated in FIG. 7, centroid weights may change between generations, and to obtain better transients, the CMA-ES centroid may be overridden or replaced whenever a new Best So Far (BSF) is found, isolating the computation of CMA-ES statistics from the resulting jump as well as from inclusion of centroids as BSF candidates. In some embodiments, a stable dynamic max-rank loss scalarization may be used to drive optimization and as a selection criterion.

### Stable Dynamic Max-Rank Loss Scalarization

In some embodiments, similar to the convex combination Σₗ₌₁^{L}wₗ [symbol] ₗ, which boils down to the l₁-norm of the loss vector [symbol] with unit weights wₗ, scalarizations may be used to combine multiple objectives so that a single objective optimizer may yield MOO solutions. Scalarization weights may be difficult to choose when loss variations are not commensurate. However, the max-rank loss may address this issue. In the context of a generation-based algorithm like the algorithm shown in FIG. 7, a max-rank loss may be defined as follows:

$${R}_{l}^{q , m , n} = rank of {ℒ}_{l}^{q , m} within \{ {ℒ}_{l}^{r , 0} \} , where 0 ∈ \{ 1 , … , n \} , r ∈ \{ 0 , … , 4 P \} , \qquad Eq . 12$$

In Eq. 12 above, ranks are counted from 0 and loss component value ties are resolved by left bisection. The weighted (left-bisection) max-rank loss M^{q, m, n} of the hyperparameter vector θ^{q,m} at the end of generation n may be as shown below:

$${M}^{q , m , n} = max ( {w}_{l} \cdot {R}_{ι}^{q , m , n} ) , where l ∈ \{ 1 , … , L \} , \qquad Eq . 13$$

By way of a non-limiting example, the max-rank loss may be dynamic, and for a given θ^{q,m}, its values may be monotone non-decreasing with respect to addition of data. Because weights multiply ranks, they are non-dimensional, which may dial in the relative importance of loss components. While each wₗ is scaled by the (damped) running proportion of individuals that “fail” to pass a user-defined threshold, and such adaptive weights may break monotonicity. However, when wₗs are kept fixed, average left and right bisection ranks may be improved to stabilize M^{q, m, n} with respect to loss value tie breaking from, e.g., noise, and creation (e.g., quantization) to define stable (dynamically monotone) max-rank loss scalarization. Further, if the left bisection rank is 0, the average may be set to 0.

### Dual-Weight CMA-ES

Besides more refined seatbelting, the algorithm illustrated in FIG. 7 may differ from earlier CMA-ES in its use of non-constant (hyperparameter, not loss) centroid weights. Although variable CMA-ES generation sizes may be common, the formula used to derive centroid weights may be invariably kept fixed. In contrast, the CMA-ES, as described herein, may alternate between gradient-seeking centroid weights, which assign zero weight to the worst quartile of each generation instead of the half to exploit the symmetry of the second and third quartiles of Gaussian distributions to get a more accurate gradient approximation. Additionally, boundary-stabilizing centroid weights with no discard may be used such that further exploration do not go in the wrong direction near generic local minima.

Additionally, or alternatively, loss of the weighted centroid of every generation may be evaluated (standard CMA-ES only generate Gaussian clouds with them) as shown by the greedy branch in lines 18-20 of the algorithm illustrated in FIG. 7, and accordingly, if any individual of the generation including, a weighted centroid, may be a strict minimizer and may become the next generation Gaussian cloud center.

### Validation

The LiDAR simulation model described in the present disclosure may be validated by jointly optimizing depth estimation and downstream 3D object detection within scenes. The proposed optimization algorithm may be compared with the 0t-order solvers, using off-the-shelf hardware LiDAR system.

### Setup of the LiDAR System

As described herein, hyperparameters affect the wavefront and DSP, and the DSP rising edge threshold V^{(m)}. In some embodiments, and by way of a non-limiting example, a predesignated number of LiDAR hyperparameters (e.g., 10 hyperparameters) may control low-level sensing parameters including the laser power P₀^{(m)} and laser pulse width T^{(m)} for each of the 128 channels.

### Optimization for Depth and Intensity

In some embodiments, point clouds may be optimized for depth and intensity with an optimizer described herein. An average root mean square error (RMSE) of the depth and an average RMSE of the intensity may be minimized using:

$${ℒ}_{depth} ( θ ) = \frac{1}{F} {\sum }_{f = 1}^{F} R M S E {R}_{{f}^{′}} {ϕ}_{f}^{( R )} ( θ ) , and \qquad Eq . 14$$

$${ℒ}_{int .} ( θ ) = \frac{1}{F} {\sum }_{f = 1}^{F} R M S E {I}_{{f}^{′}} {ϕ}_{f}^{( I )} ( θ ) , \qquad Eq . 15$$

In Eq. 14 and Eq. 15 above, F corresponds with the number of frames in the validation set. The depth loss [symbol] _{depth} rewards accurate point cloud depth estimates over the full range, whereas [symbol] _{int.} ensures that accurate intensities are measured with the pulse power P₀^{(j)}. Generally, high output power may result in more accurate point clouds at father distances but may also lead to excessive saturation. Further, [symbol] _{int.} penalizes saturation.

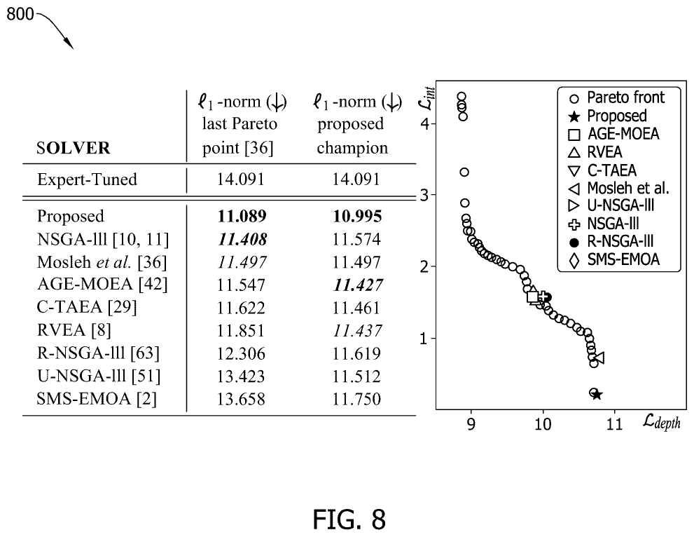

FIG. 8 is a table 800 showing an example comparison of the optimization algorithm shown in FIG. 7 with other state-of-the-art multi-objective optimization (MOO) optimizers. Compared to the optimized point cloud measurement, an expert-tuned point cloud suffers from clutter, and its depth error increases with distance. The table 800 illustrated in FIG. 8 indicates that the optimization method, as described herein, may improve the depth and intensity metrics by about 12% and 89%, respectively, in some examples. The expert-tuned configuration may have a loss vector [symbol] =( [symbol] _{depth}, [symbol] _{int.}) equal to (12.195, 1.971) in comparison with the loss vector of (10.754, 0.216), which corresponds with the depth and intensity metrics improvements by about 12% and 89%, respectively. The loss weights wₗ in Eq. 13 above may be changed for biasing optimization toward reducing RMSE_{depth} more than RMSEᵢₙₜ. Additionally, or alternatively, loss component weights may be set to default 1. The table 800 also shows a comparison of the algorithm shown in FIG. 7 with other state-of-the-art MOO optimizers.

### Optimization for Object Detection

In some embodiments, and by way of a non-limiting example, an optimization for object detection and classification may be performed using Average Precision (AP) as an additional optimization objective, in which AP is maximized for cars and pedestrians at 40 recall positions over an optimization set with F=100 frames, as shown in Eq. 16 below.

$${ℒ}_{obj , \{ car , ped . \}} ( θ ) = - A {P}_{\{ car , ped . \}} ( Φ ( θ ) ) , \qquad Eq . 16$$

In standard Karlsruhe Institute of Technology and Toyota Technological Institute (KITTI) IoU thresholds, the CV loss is evaluated over a 0-80 m range. A PointVoxel Region-based Convolutional Neural Network (PV-RCNN) for 3D object detection may be trained on 5900 full range point clouds collected from the simulation environment with 8 different expert-tuned parametrizations θ.

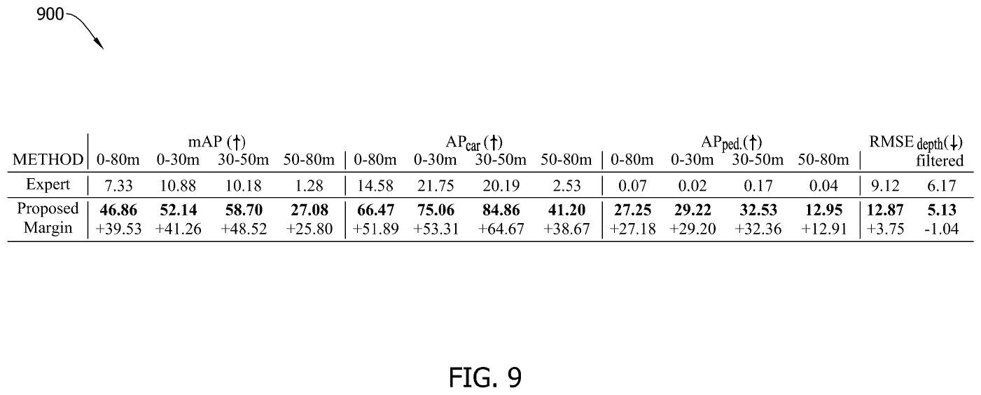

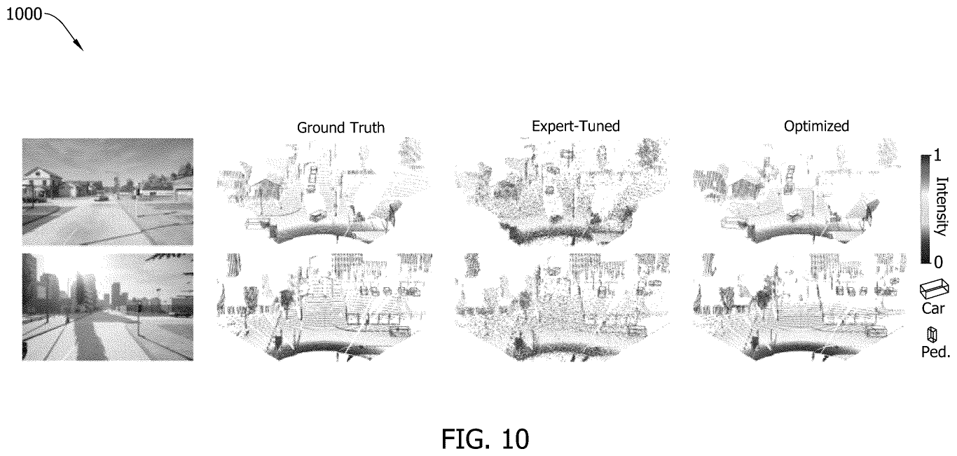

FIG. 9 is a table 900 showing an example comparison of hyperparameter optimization by an expert in comparison with the hyperparameter optimization algorithm shown in FIG. 7. The table 900 shown in FIG. 9 illustrates a quantitative comparison between the method described herein and the expert tuning. As shown in the table 900, the optimization method described herein may increase AP, in comparison to the expert-tuning, by about 52.9% and 27.2% for cars and pedestrians, respectively, on the full 0-80 m range. A large increase in improvement may predominately be at close range. By way of a non-limiting example, lower AP values in the 0-30 m range compared to 30-50 m may be due to a lower object occurrence (3.2 per frame vs. 3.6) and a varied distribution of object yaw angles (std. dev. Of 0.63 rad vs. 1.25 rad) within the training set. Consequently, the detector may be better adapted within the 30-50 m bin. The quantitative findings agree with the qualitative results shown in FIG. 10 and described below, where optimized and expert-tuned point clouds are compared to the ground truth. The clutter in the expert-tuned point cloud may result in false positives and missed detections. By way of a non-limiting example, the optimization method, as described herein, may miss about one pedestrian, whereas on the expert-tuned point cloud, the detector may miss all pedestrians. When the average depth RMSE is compared before and after filtering suppressed points, the low loss of the filtered point cloud may suggest that the clutter has been removed and that the detector prefers an accurate, if sparser point cloud. A DSP optimized for the removal of clutter, using the optimization method described herein, may also suppress ground points, with a small impact on object detection results, as shown in the last column of the table 900.

### Off-the-Shelf LiDAR Optimization

The optimization algorithm shown in FIG. 7 may be adapted to an off-the-shelf LiDAR sensor (e.g., Baraja Spectrum LiDAR sensor) for which a small set of hyperparameters including a return mode that selects the waveform peaks that are used to generate the point cloud, the sensor heads scanning pattern, and two sensor head motor frequencies that determine the point cloud angular resolution compared to the sensor noise balance may be accessible for tuning. Because raw waveforms are inaccessible, 3D point cloud histograms taken over a static scene may be optimized. In some examples, the static scene may be intermittently taken.

FIG. 10 illustrates an example graph 1000 showing a comparison between ground-truth, expert-tuned and optimized point cloud for 3D object detection. Optimization may result in clutter-free point clouds, which helps reduce false positive detections. For visualization purposes, only the camera field-of-view is shown.

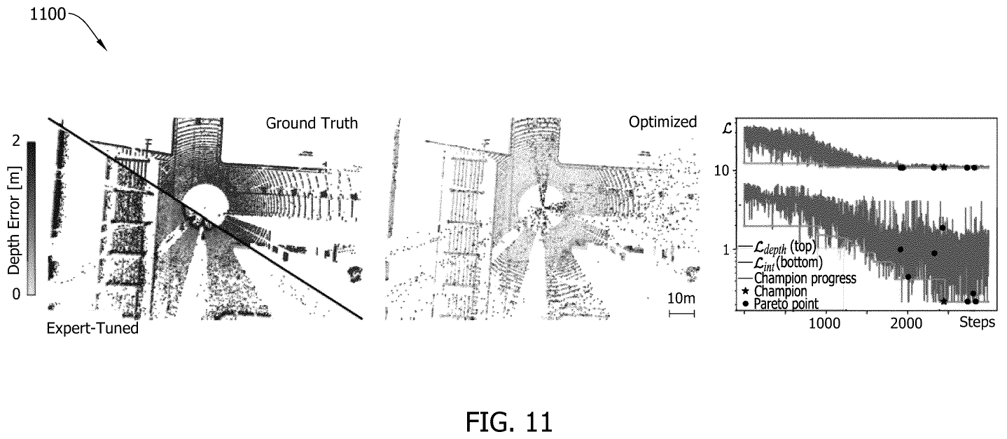

FIG. 11 illustrates an example graph 1100 showing a comparison between expert-tuned and optimized point clouds in which colors encode the individual depth error of each point, which may be clipped at 2 m. Convergence plot in FIG. 11 shows that loss components [symbol] _{depth} and [symbol] _{int.} represented above using Eq. 14 and Eq. 15 against an optimization step [symbol] (e.g., 3000 loss evaluations total), the evolution of the champion and the final Pareto front, champion included.

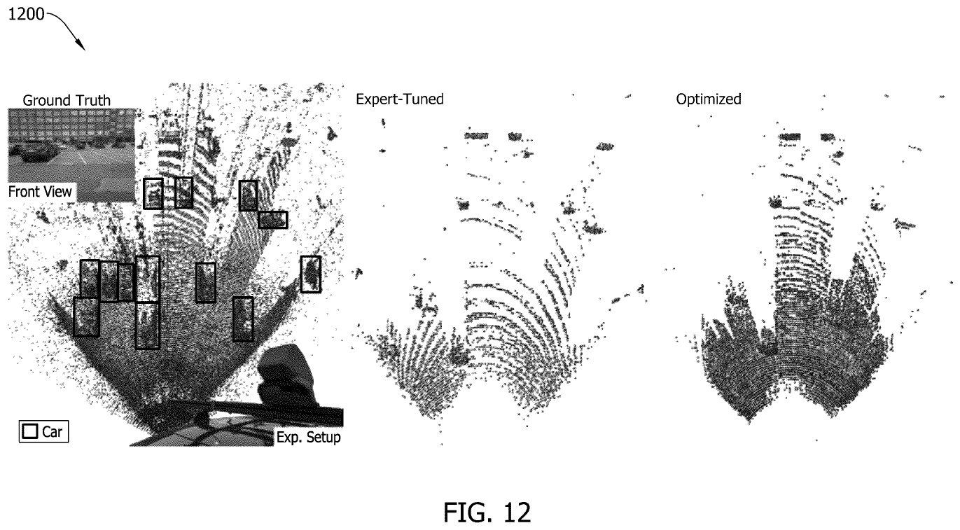

FIG. 12 illustrates an example test fixture 1200 along with a photograph of an example scene over which optimization is performed. The ground truth histogram is shown on the left of FIG. 12, which is generated by averaging 100 captures with a uniform angular resolution scanning pattern. Expert-tuned and optimized histogram contributions to the fitness function are respectively shown in the middle and right of FIG. 12 where brighter bins indicate larger contributions. Optimized hyperparameters achieved better results by focusing laser scans in regions of interests (ROIs) where the ground truth was denser, whereas expert-tuned ones produced more uniform point clouds. Using the RMSE of PC histograms weighted by distance and number of points per bin, an error may be estimated to be of 10.1 cm for the expert-tuned configuration compared to 3.0 cm with optimized hyperparameters.

Accordingly, the in-the-loop black box 0th-order optimization method for LiDAR sensing pipelines as described herein finds optimal parameters for depth and intensity estimation and 3D object detection and classification. To assess the in-the-loop black box 0th-order optimization method, a LiDAR simulation method may be integrated into the CARLA simulator. Accordingly, optimizing the LiDAR sensing pipeline may significantly improve depth, intensity and object detection and classification compared to manual expert tuning. Specifically, for 3D object detection our optimization method may result in a major increase of 51.9% AP for cars and 27.2% AP for pedestrians, compared to fine-tuning a detector on expert-optimized LiDAR vendor parameters. Further, real-time scene-dependent optimization of LiDAR scanning parameters may be performed, which may potentially lead to adaptive sensing in adverse weather in urban and highway scenarios.

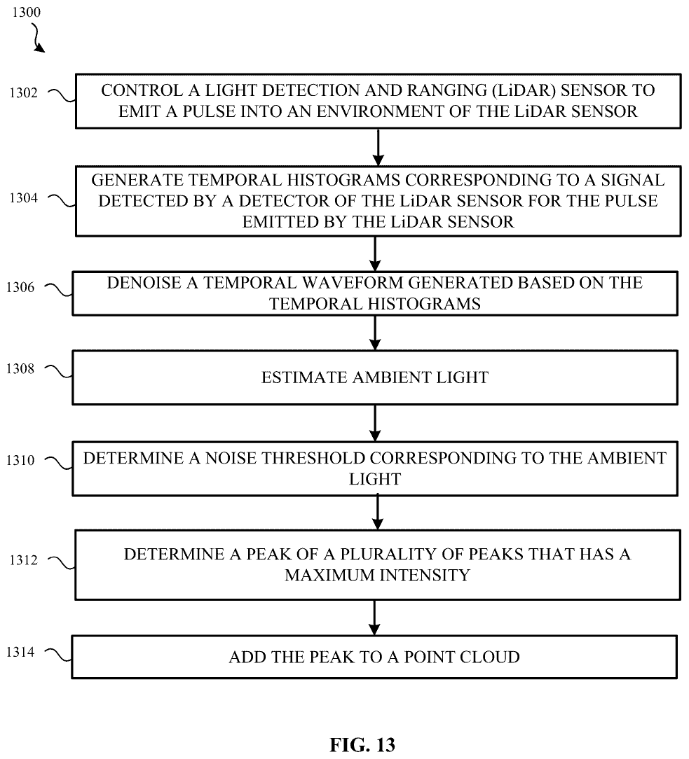

FIG. 13 illustrates an exemplary flow-chart 1300 of method operations performed by an autonomy computing system 200 or a computing system 300. The method operations may include controlling 1302 a LiDAR sensor to emit a pulse into an environment of the LiDAR sensor. The LiDAR sensor may be positioned on a body of a vehicle. By way of a non-limiting example, the power level of the pulse emitted by the LiDAR sensor may be selected from a plurality power levels, and a pulse duration of the emitted pulse may range from 3 ns to 15 ns.

The method operations may also include generating 1304 temporal histograms corresponding to a signal detected by a detector of the LiDAR sensor for the pulse emitted 1302 by the LiDAR sensor. The detector of the LiDAR sensor may be a SPAD detector. Further, the generated 1304 temporal waveform may be denoised 1306 based on temporal histograms by convolving the waveform with the pulse emitted by the LiDAR sensor, and ambient light may be estimated 1308 by removing the temporal waveform's median from noisy and saturated waveforms. A noise threshold corresponding to the estimated 1308 ambient light may be determined 1310, and a peak of a plurality of peaks having the maximum intensity may be determined 1312. The determined peak 1312 may be added to a point cloud. Additionally, or alternatively, true intensity of the peak may be recovered by compensating the maximum intensity of the peak using a half pulse width and power level of the pulse as scaling factors. Further, an edge threshold may be determined as a continuous parameter having a value between 0 and 2. The determined continuous parameter is the determined 1310 noise threshold.

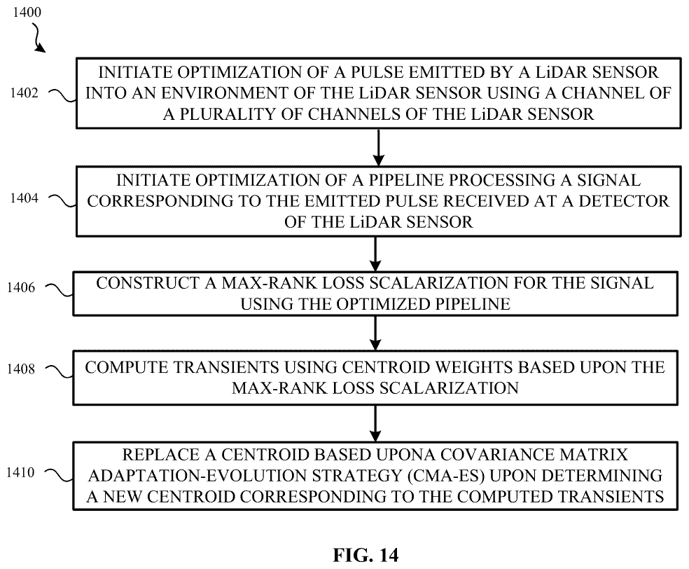

FIG. 14 illustrates an exemplary flow-chart 1400 of method operations performed by an autonomy computing system 200 or a computing system 300. The method operations may include initiating 1402 optimization of a pulse emitted by a LiDAR sensor into an environment of the LiDAR sensor using a respective channel of a plurality of channels of the LiDAR sensor. The LiDAR sensor may be positioned on a body of a vehicle. The method operations may include initiating 1404 optimization of a pipeline processing a signal corresponding to the emitted pulse received at a detector of the LiDAR sensor. The optimization of the pipeline processing may be initiated by modulating the pipeline using a set of hyperparameters. The set of hyperparameters may include a rising edge threshold, a laser power of the emitted pulse, and a laser pulse width of the pulse. The modulated pipeline may map a set of truncated waveforms to a point cloud including compressed information to downstream detectors.

The method operations may include constructing 1406 a max-rank loss scalarization for the signal using the optimized 1404 pipeline, and computing 1408 transients using centroid weights based upon the max-rank loss scalarization. Further, corresponding to the computed 1408 transients and based upon a CMA-ES, upon determining a new centroid, replacing 1410 a centroid with the new centroid. The max-rank loss scalarization may be dynamic. Additionally, or alternatively, the max-rank loss scalarization may be a stable max-rank loss scalarization based on keeping a weight associated with each loss vector fixed or stabilizing the weighted max-rank loss with respect to loss value tie breaking from noise and quantization.

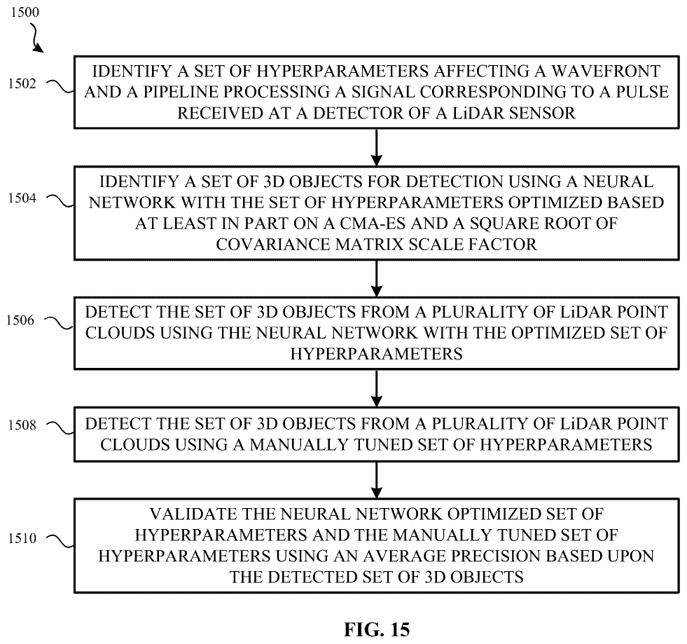

FIG. 15 illustrates an exemplary flow-chart 1500 of method operations performed by an autonomy computing system 200 or a computing system 300. The method operations may include identifying 1502 a set of hyperparameters affecting a wavefront and a pipeline processing a signal corresponding to a pulse received at a detector of a LiDAR sensor. The pulse is emitted using a channel of a plurality of channels of the LiDAR sensor. The LiDAR sensor may be positioned on a body of a vehicle. The method operations may include identifying 1504 a set of 3-dimensional (3D) objects for detection using a neural network with the set of hyperparameters optimized based at least in part on a Covariance Matrix Adaptation-Evolution Strategy (CMA-ES) and a square root of covariance matrix scale factor. The method operations may include detecting 1506 the set of 3D objects from a plurality of LiDAR point clouds using the neural network with the optimized set of hyperparameters and detecting 1508 the set of 3D objects from the plurality of LiDAR point clouds using manually tuned set of hyperparameters. The method operations may include validating 1510 the neural network optimized set of hyperparameters and the manually tuned set of hyperparameters using an average precision based upon the detected set of 3D objects corresponding to the optimized set of hyperparameters and the manually tuned set of hyperparameters.

Various functional operations of the embodiments described herein may be implemented using machine learning algorithms, and performed by one or more local or remote processors, transceivers, servers, and/or sensors, and/or via computer-executable instructions stored on non-transitory computer-readable media or medium.

In some embodiments, the machine learning algorithms may be implemented, such that a computer system “learns” to analyze, organize, and/or process data without being explicitly programmed. Machine learning may be implemented through machine learning methods and algorithms (“ML methods and algorithms”). In one exemplary embodiment, a machine learning module (“ML module”) is configured to implement ML methods and algorithms. In some embodiments, ML methods and algorithms are applied to data inputs and generate machine learning outputs (“ML outputs”). Data inputs may include but are not limited to images. ML outputs may include, but are not limited to identified objects, items classifications, and/or other data extracted from the images. In some embodiments, data inputs may include certain ML outputs.

In some embodiments, at least one of a plurality of ML methods and algorithms may be applied, which may include but are not limited to: linear or logistic regression, instance-based algorithms, regularization algorithms, decision trees, Bayesian networks, cluster analysis, association rule learning, artificial neural networks, deep learning, combined learning, reinforced learning, dimensionality reduction, and support vector machines. In various embodiments, the implemented ML methods and algorithms are directed toward at least one of a plurality of categorizations of machine learning, such as supervised learning, unsupervised learning, and reinforcement learning.

In one embodiment, the ML module employs supervised learning, which involves identifying patterns in existing data to make predictions about subsequently received data. Specifically, the ML module is “trained” using training data, which includes example inputs and associated example outputs. Based upon the training data, the ML module may generate a predictive function which maps outputs to inputs and may utilize the predictive function to generate ML outputs based upon data inputs. The example inputs and example outputs of the training data may include any of the data inputs or ML outputs described above. In the exemplary embodiment, a processing element may be trained by providing it with a large sample of images with known characteristics or features or with a large sample of other data with known characteristics or features. Such information may include, for example, information associated with a plurality of images and/or other data of a plurality of different objects, items, or property.

In another embodiment, a ML module may employ unsupervised learning, which involves finding meaningful relationships in unorganized data. Unlike supervised learning, unsupervised learning does not involve user-initiated training based upon example inputs with associated outputs. Rather, in unsupervised learning, the ML module may organize unlabeled data according to a relationship determined by at least one ML method/algorithm employed by the ML module. Unorganized data may include any combination of data inputs and/or ML outputs as described above.

In yet another embodiment, a ML module may employ reinforcement learning, which involves optimizing outputs based upon feedback from a reward signal. Specifically, the ML module may receive a user-defined reward signal definition, receive a data input, utilize a decision-making model to generate a ML output based upon the data input, receive a reward signal based upon the reward signal definition and the ML output, and alter the decision-making model so as to receive a stronger reward signal for subsequently generated ML outputs. Other types of machine learning may also be employed, including deep or combined learning techniques.

In some embodiments, generative artificial intelligence (AI) models (also referred to as generative machine learning (ML) models) may be utilized with the present embodiments and may the voice bots or chatbots discussed herein may be configured to utilize artificial intelligence and/or machine learning techniques. For instance, the voice or chatbot may be a ChatGPT chatbot. The voice or chatbot may employ supervised or unsupervised machine learning techniques, which may be followed by, and/or used in conjunction with, reinforced or reinforcement learning techniques. The voice or chatbot may employ the techniques utilized for ChatGPT. The voice bot, chatbot, ChatGPT-based bot, ChatGPT bot, and/or other bots may generate audible or verbal output, text, or textual output, visual or graphical output, output for use with speakers and/or display screens, and/or other types of output for user and/or other computer or bot consumption.

In some embodiments, various functional operations of the embodiments described herein may be implemented using an artificial neural network model. The artificial neural network may include multiple layers of neurons, including an input layer, one or more hidden layers, and an output layer. Each layer may include any number of neurons. It should be understood that neural networks of a different structure and configuration may be used to achieve the methods and systems described herein.

In the exemplary embodiment, the input layer may receive different input data. For example, the input layer includes a first input a₁ representing training images, a second input a₂ representing patterns identified in the training images, a third input a₃ representing edges of the training images, and so on. The input layer may include thousands or more inputs. In some embodiments, the number of elements used by the neural network model changes during the training process, and some neurons are bypassed or ignored if, for example, during execution of the neural network, they are determined to be of less relevance.

In some embodiments, each neuron in hidden layer(s) may process one or more inputs from the input layer, and/or one or more outputs from neurons in one of the previous hidden layers, to generate a decision or output. The output layer includes one or more outputs each indicating a label, confidence factor, weight describing the inputs, an output image, or a point cloud. In some embodiments, however, outputs of the neural network model may be obtained from a hidden layers in addition to, or in place of, output(s) from the output layer(s).

In some embodiments, each layer has a discrete, recognizable function with respect to input data. For example, if n is equal to 3, a first layer analyzes the first dimension of the inputs, a second layer the second dimension, and the final layer the third dimension of the inputs. Dimensions may correspond to aspects considered strongly determinative, then those considered of intermediate importance, and finally those of less relevance.

In some embodiments, the layers may not be clearly delineated in terms of the functionality they perform. For example, two or more of hidden layers may share decisions relating to labeling, with no single layer making an independent decision as to labeling.

Based upon these analyses, the processing element may learn how to identify characteristics and patterns that may then be applied to analyzing and classifying objects. The processing element may also learn how to identify attributes of different objects in different lighting. This information may be used to determine which classification models to use and which classifications to provide.

Some embodiments involve the use of one or more electronic processing or computing devices. As used herein, the terms “processor” and “computer” and related terms, e.g., “processing device,” and “computing device” are not limited to just those integrated circuits referred to in the art as a computer, but broadly refers to a processor, a processing device or system, a general purpose central processing unit (CPU), a graphics processing unit (GPU), a microcontroller, a microcomputer, a programmable logic controller (PLC), a reduced instruction set computer (RISC) processor, a field programmable gate array (FPGA), a digital signal processor (DSP), an application specific integrated circuit (ASIC), and other programmable circuits or processing devices capable of executing the functions described herein, and these terms are used interchangeably herein. These processing devices are generally “configured” to execute functions by programming or being programmed, or by the provisioning of instructions for execution. The above examples are not intended to limit in any way the definition or meaning of the terms processor, processing device, and related terms.

The various aspects illustrated by logical blocks, modules, circuits, processes, algorithms, and algorithm steps described above may be implemented as electronic hardware, software, or combinations of both. Certain disclosed components, blocks, modules, circuits, and steps are described in terms of their functionality, illustrating the interchangeability of their implementation in electronic hardware or software. The implementation of such functionality varies among different applications given varying system architectures and design constraints. Although such implementations may vary from application to application, they do not constitute a departure from the scope of this disclosure.

Aspects of embodiments implemented in software may be implemented in program code, application software, application programming interfaces (APIs), firmware, middleware, microcode, hardware description languages (HDLs), or any combination thereof. A code segment or machine-executable instruction may represent a procedure, a function, a subprogram, a routine, a subroutine, a module, a software package, a class, or any combination of instructions, data structures, or program statements. A code segment may be coupled to, or integrated with, another code segment or an electronic hardware by passing or receiving information, data, arguments, parameters, memory contents, or memory locations. Information, arguments, parameters, data, etc. may be passed, forwarded, or transmitted via any suitable means including memory sharing, message passing, token passing, network transmission, etc.

The actual software code or specialized control hardware used to implement these systems and methods is not limiting of the claimed features or this disclosure. Thus, the operation and behavior of the systems and methods were described without reference to the specific software code being understood that software and control hardware can be designed to implement the systems and methods based on the description herein.

When implemented in software, the disclosed functions may be embodied, or stored, as one or more instructions or code on or in memory. In the embodiments described herein, memory includes non-transitory computer-readable media, which may include, but is not limited to, media such as flash memory, a random access memory (RAM), read-only memory (ROM), erasable programmable read-only memory (EPROM), electrically erasable programmable read-only memory (EEPROM), and non-volatile RAM (NVRAM). As used herein, the term “non-transitory computer-readable media” is intended to be representative of any tangible, computer-readable media, including, without limitation, non-transitory computer storage devices, including, without limitation, volatile and non-volatile media, and removable and non-removable media such as a firmware, physical and virtual storage, CD-ROM, DVD, and any other digital source such as a network, a server, cloud system, or the Internet, as well as yet to be developed digital means, with the sole exception being a transitory propagating signal. The methods described herein may be embodied as executable instructions, e.g., “software” and “firmware,” in a non-transitory computer-readable medium. As used herein, the terms “software” and “firmware” are interchangeable and include any computer program stored in memory for execution by personal computers, workstations, clients, and servers. Such instructions, when executed by a processor, configure the processor to perform at least a portion of the disclosed methods.

As used herein, an element or step recited in the singular and proceeded with the word “a” or “an” should be understood as not excluding plural elements or steps unless such exclusion is explicitly recited. Furthermore, references to “one embodiment” of the disclosure or an “exemplary” or “example” embodiment are not intended to be interpreted as excluding the existence of additional embodiments that also incorporate the recited features. Likewise, limitations associated with “one embodiment” or “an embodiment” should not be interpreted as limiting to all embodiments unless explicitly recited.

Disjunctive language such as the phrase “at least one of X, Y, or Z,” unless specifically stated otherwise, is generally intended, within the context presented, to disclose that an item, term, etc. may be either X, Y, or Z, or any combination thereof (e.g., X, Y, and/or Z). Likewise, conjunctive language such as the phrase “at least one of X, Y, and Z,” unless specifically stated otherwise, is generally intended, within the context presented, to disclose at least one of X, at least one of Y, and at least one of Z.

The disclosed systems and methods are not limited to the specific embodiments described herein. Rather, components of the systems or steps of the methods may be utilized independently and separately from other described components or steps.

This written description uses examples to disclose various embodiments, which include the best mode, to enable any person skilled in the art to practice those embodiments, including making and using any devices or systems and performing any incorporated methods. The patentable scope is defined by the claims and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. A system, comprising:
at least one memory storing instructions; and
at least one processor in communication with the at least one memory, wherein the at least one processor is configured to execute the stored instructions to:
identify a set of hyperparameters affecting a wavefront and a pipeline processing a signal corresponding to a pulse received at a detector of a light detection and ranging (LiDAR) sensor, wherein the pulse is emitted using a channel of a plurality of channels of the LiDAR sensor;
identify a set of 3-dimensional (3D) objects for detection using a neural network with the set of hyperparameters optimized based at least in part on a Covariance Matrix Adaptation-Evolution Strategy (CMA-ES) and a square root of covariance matrix scale factor;
detect the set of 3D objects from a plurality of LiDAR point clouds using the neural network with the optimized set of hyperparameters;
detect the set of 3D objects from the plurality of LiDAR point clouds using a manually tuned set of hyperparameters; and
validate the neural network optimized set of hyperparameters and the manually tuned set of hyperparameters using an average precision based upon the detected set of 3D objects corresponding to the optimized set of hyperparameters and the manually tuned set of hyperparameters.

2. The system of claim 1, wherein the set of hyperparameters includes a rising edge threshold control parameter and low-level sensing control parameters.

3. The system of claim 2, wherein the low-level sensing control parameters include a laser power and a laser pulse width.

4. The system of claim 2, wherein the set of hyperparameters further includes a return mode that selects waveform peaks used for generating a point cloud.

5. The system of claim 2, wherein the set of hyperparameters further includes a LiDAR sensor head scanning pattern, or at least two sensor head motor frequencies.

6. The system of claim 2, wherein the set of hyperparameters further includes at least two sensor head motor frequencies that determine a point cloud angular resolution and a LiDAR sensor noise balance.

7. The system of claim 1, wherein the set of 3D objects includes at least a vehicle and a pedestrian.

8. A computer-implemented method comprising:
identifying a set of hyperparameters affecting a wavefront and a pipeline processing a signal corresponding to a pulse received at a detector of a light detection and ranging (LiDAR) sensor, wherein the pulse is emitted using a channel of a plurality of channels of the LiDAR sensor;
identifying a set of 3-dimensional (3D) objects for detection using a neural network with the set of hyperparameters optimized based at least in part on a Covariance Matrix Adaptation-Evolution Strategy (CMA-ES) and a square root of covariance matrix scale factor;
detecting the set of 3D objects from a plurality of LiDAR point clouds using the neural network with the optimized set of hyperparameters;
detecting the set of 3D objects from the plurality of LiDAR point clouds using a manually tuned set of hyperparameters; and
validating the neural network optimized set of hyperparameters and the manually tuned set of hyperparameters using an average precision based upon the detected set of 3D objects corresponding to the optimized set of hyperparameters and the manually tuned set of hyperparameters.

9. The computer-implemented method of claim 8, wherein the set of hyperparameters includes a rising edge threshold control parameter and low-level sensing control parameters.

10. The computer-implemented method of claim 9, wherein the low-level sensing control parameters include a laser power and a laser pulse width.

11. The computer-implemented method of claim 9, wherein the set of hyperparameters further includes a return mode that selects waveform peaks used for generating a point cloud.

12. The computer-implemented method of claim 9, wherein the set of hyperparameters further includes a LiDAR sensor head scanning pattern, or at least two sensor head motor frequencies.

13. The computer-implemented method of claim 9, wherein the set of hyperparameters further includes at least two sensor head motor frequencies that determine a point cloud angular resolution and a LiDAR sensor noise balance.

14. The computer-implemented method of claim 8, wherein the set of 3D objects includes at least a vehicle and a pedestrian.

15. A vehicle, comprising:
a light detection and ranging (LiDAR) sensor;
at least one memory storing instructions; and
at least one processor in communication with the at least one memory, wherein the at least one processor is configured to execute the stored instructions to:
identify a set of hyperparameters affecting a wavefront and a pipeline processing a signal corresponding to a pulse received at a detector of the LiDAR sensor, wherein the pulse is emitted using a channel of a plurality of channels of the LiDAR sensor;
identify a set of 3-dimensional (3D) objects for detection using a neural network with the set of hyperparameters optimized based at least in part on a Covariance Matrix Adaptation-Evolution Strategy (CMA-ES) and a square root of covariance matrix scale factor;
detect the set of 3D objects from a plurality of LiDAR point clouds using the neural network with the optimized set of hyperparameters;
detect the set of 3D objects from the plurality of LiDAR point clouds using a manually tuned set of hyperparameters; and
validate the neural network optimized set of hyperparameters and the manually tuned set of hyperparameters using an average precision based upon the detected set of 3D objects corresponding to the optimized set of hyperparameters and the manually tuned set of hyperparameters.

16. The system of claim 1, wherein the set of hyperparameters includes a rising edge threshold control parameter and low-level sensing control parameters, wherein the low-level sensing control parameters include a laser power and a laser pulse width.

17. The vehicle of claim 16, wherein the set of hyperparameters further includes a return mode that selects waveform peaks used for generating a point cloud.

18. The vehicle of claim 16, wherein the set of hyperparameters further includes a LiDAR sensor head scanning pattern, or at least two sensor head motor frequencies.

19. The vehicle of claim 16, wherein the set of hyperparameters further includes at least two sensor head motor frequencies that determine a point cloud angular resolution and a LiDAR sensor noise balance.

20. The vehicle of claim 15, wherein the set of 3D objects includes at least a vehicle and a pedestrian.
